(19) United States
(12) Patent Application Publication
(10) Pub. No.: US 2021/0387212 A1
(43) Pub. Date: Dec. 16, 2021

(54) Cross Jet Cleaning Nozzle, Produced By Additive Manufacturing

(71) Applicant: Enz Technik AG, Giswil (CH)

(72) Inventor: Christoph Lendi, Giswil (CH)

(73) Assignee: Enz Technik AG, Giswil (CH)

(21) Appl. No.: 17/333,447

(22) Filed: May 28, 2021

(30) Foreign Application Priority Data
Jun. 11, 2020 (CH) CH00692/20

(51) Int. Cl. B05B 3/06; B33Y 80/00; B08B 9/043

(52) U.S. Cl. CPC B05B 3/06; B08B 2209/04; B08B 9/0433; B33Y 80/00

(57) ABSTRACT

A rotor body is completely produced from metal by means of additive manufacturing methods or 3D printing, wherein the cross-jet nozzle duct is left out during the additive manufacturing layer by layer as a continuous edge-free curved opening in the form of an arc curved in relation to the longitudinal axis (L). A cleaning fluid can be transported from a feed duct of the rotor body up to a nozzle tip (D) and can be dispensed there from the cross jet nozzle outlet, and accordingly higher-energy cleaning fluid chats are to be able to be generated or an energy loss of the exiting cleaning fluid is to be reduced.

### CROSS-REFERENCE TO RELATED APPLICATIONS

This application claims priority to Switzerland Application Number CH00692/20 filed Jun. 11, 2020, which is incorporated herein by reference in its entirety.

### TECHNICAL FIELD

The present invention describes a rotor body of a cross jet cleaning nozzle, connectable to a stator including high-pressure line fitting, wherein a feed duct partially crosses the rotor body and from which at least one cross jet nozzle duct is left out in a manner extending branching off, wherein the cross jet nozzle duct includes an inlet section, a guide section, and a cross jet nozzle outlet, left out inside the rotor body with various alignments relative to a longitudinal axis, so that a cleaning fluid can be transported from the feed duct up to a nozzle tip and can be dispensed there from the cross jet nozzle outlet, a production method for manufacturing a rotor body of a cross jet cleaning nozzle, and a lance of a lance device for cleaning pipe bundles having at least one cross jet cleaning nozzle.

### BACKGROUND

So-called cross jet cleaning nozzles for cleaning pipes and shafts are known as a subtype of high-pressure pipe cleaning nozzles. Such cross-jet cleaning nozzles include a rotor body having a plurality of ducts and nozzles, which is rotatably mounted on a stator body in the installed state. A rotor body 10 according to the prior art is shown in a schematic longitudinal section in FIG. 1. Two cross jet cleaning nozzle ducts 103 are left out in the rotor body in such a way that exiting cleaning fluid jets, indicated by dashed lines, intersect in operation.

In practice, the rotor body or the cross-jet cleaning nozzle is preferably placed on the lance of a lance device operable in a controlled manner for automatically cleaning pipe bundles. A person skilled in the art knows of lances and lance devices, which are therefore not further explained or shown here for the sake of simplicity. The rotor body is rotatably mounted around a longitudinal axis L, wherein the nozzles have different functions.

A branch duct 102 and further ones, which lead to various outlets, originate from a central feed duct 101, indicated by dashed lines in FIG. 1, which crosses the stator body and the rotor body in the direction of longitudinal axis L. The two cross jet ducts 103 arranged in the rotor body 10, which extend at an angle to one another, are the namesakes of the cross-jet cleaning nozzle 1. The cleaning fluid or pressurized medium flows from the feed duct 101 via the nozzles targeted in different directions and, depending on the geometry of the ducts and applied pressure, at defined speeds out of the rotor body 10. The nozzle geometry of the cross-jet cleaning nozzle ducts 103 has heretofore not been varied for technical reasons and is in general adapted to desired beam shapes by nozzle inserts which can be placed, but which will not be discussed in greater detail here.

The at least two cross jet nozzle ducts 103 are arranged in the region of a nozzle tip D in such a way that cross jets of the pressurized medium result, which intersect or cross outside the rotor body 10, whereby a cross jet made up of at least fluid jets is formed.

The known cross jet cleaning nozzles are, as are other pipe cleaning nozzles, produced from metal, are milled from solid material, and include drilled desired nozzle ducts, drilled in different directions. The nozzle ducts are introduced into the rotor body, as is recognizable in FIG. 1, in a straight line from multiple sides or in various directions into the rotor body. This type of production has proven itself and has resulted in inexpensive suitable cross jet cleaning nozzles having good cleaning results.

However, it has been shown again and again in operation that even at very high cleaning fluid pressures, energy of the cleaning fluid jets from the cross-jet cleaning nozzles is lost. Attempts have been made to adapt to this by further increasing the cleaning fluid pressure. However, it was not possible to improve this adequately using increased feed pressures for known rotor bodies or cross jet cleaning nozzles.

### SUMMARY

The above-described disadvantages known from the prior art are to be remedied by the present device.

The present invention has the stated object of providing a rotor body of a cross jet cleaning nozzle which permits higher-energy cleaning fluid jets in comparison to the prior art.

This object is achieved by a rotor body of a cross jet cleaning nozzle having the features of claim 1.

Variations of feature combinations or minor adaptations of the invention are to be found in the detailed description, are depicted in the figures, and have been incorporated into the dependent claims.

The stated object is achieved by a device having the features of claim 1, wherein the production method of the rotor body is also claimed.

Since the rotor body according to the invention of cross jet cleaning nozzles is usable in suitable lances of lance devices and is advantageously used in practice, a correspondingly equipped lance of the lance device having at least one cross jet cleaning nozzle is also claimed.

### BRIEF DESCRIPTION OF THE DRAWINGS

The subject matter of the invention is described in detail hereinafter in conjunction with the appended drawings. Required features, details, and advantages of the invention result from this following description, wherein a preferred embodiment of the invention and several additional features or optional features are set forth in detail.

In the figures:

FIG. 1 shows a schematic sectional illustration of a rotor body known from the prior art.

FIG. 2 shows a schematic partial sectional view along the longitudinal axis of a cross jet cleaning nozzle having rotor body according to the invention, while

FIG. 3a shows a frontal view of the cross-jet cleaning nozzle or the rotor body, and

FIG. 3b shows a longitudinal section through the rotor body alone.

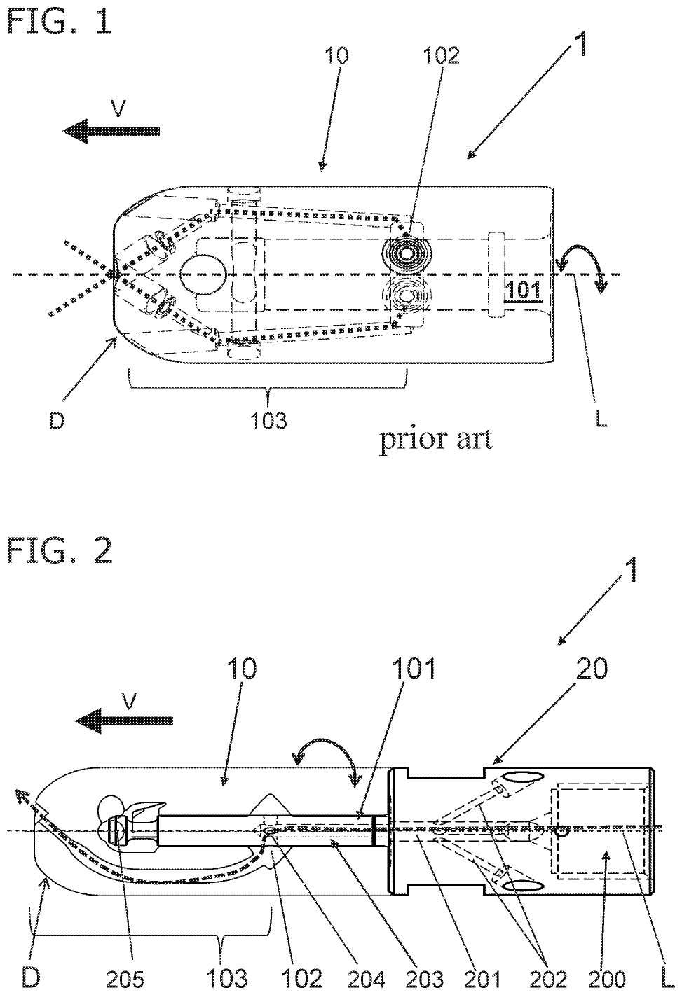

### DETAILED DESCRIPTION

A cross jet cleaning nozzle 1 is described, which comprises a rotor body 10 having a plurality of ducts and nozzles. The cross-jet cleaning nozzle 1 is formed in two parts here, wherein the rotor body 10 is rotatably mounted on a stator body 20. For the sake of simplicity, a lance and a lance device are not shown here, but rather the cross-jet cleaning nozzle 1 alone. The rotor body 10 is rotatably mounted around a longitudinal axis L, is releasably connected to the stator body 20, and the possible rotation is identified by a double arrow in FIG. 2, wherein the nozzles have different functions.

A feed duct 101, a branching duct 102, and two cross jet nozzle ducts 103 are left out in the rotor body 10.

Nozzle inserts are generally introduced into the outlets of the ducts after the production of the rotor body 10 or the stator body 20 and pressurized medium, generally water, at pressures of up to 3000 bar is applied to the cross-jet cleaning nozzle 1 by means of a high-pressure fitting. Even upon rotation of the rotor body 10 at several hundred RPM, the cross-jet cleaning nozzle 1 can be guided easily and safely through pipes in advance direction V.

A feed section 200 is arranged on the rotationally fixed stator body 20, to which a hose having cleaning fluid under high pressure can be coupled. The feed section 200 opens into a stator feed duct 201, which is left out, preferably extending concentrically to the longitudinal axis L of the stator body 20. On the stator body side, the stator feed duct 201 opens into at least one recoil nozzle duct 202. Three recoil nozzle ducts 202 are provided here, the outlets of which are provided with nozzle inserts (not shown). These recoil nozzle ducts 202 supply a recoil to the movement in advance direction V. The stator feed duct 201 extends further into a rotor body mounting 203, on which the rotor body 10 is rotatably mounted and which is inserted into the feed duct 101 in the rotor body 10. In the course of the stator feed duct 201, it opens into a central outlet 204. Cleaning fluid can thus finally exit from the stator body 20 or the stator feed duct 201 into the feed duct 101 or the branching duct 102 in the rotor body 10. Stator body 20 and rotor body 10 are releasably connected to one another. Fastening means, which prevent a linear movement of the rotor body 10 relative to the stator body 20, are arranged in the region of the stator body tip 205 on the stator body 20 and in the corresponding region of the feed duct 101 in the rotor body 10. With the nozzle tip D in front, the cross jet cleaning nozzle 1 is guided through pipes, the pipe internal diameter of which can be only slightly larger than the external diameter of the rotor body 10. An optimum cleaning effect can be achieved by the cross jets from both cross-jet nozzle ducts 103.

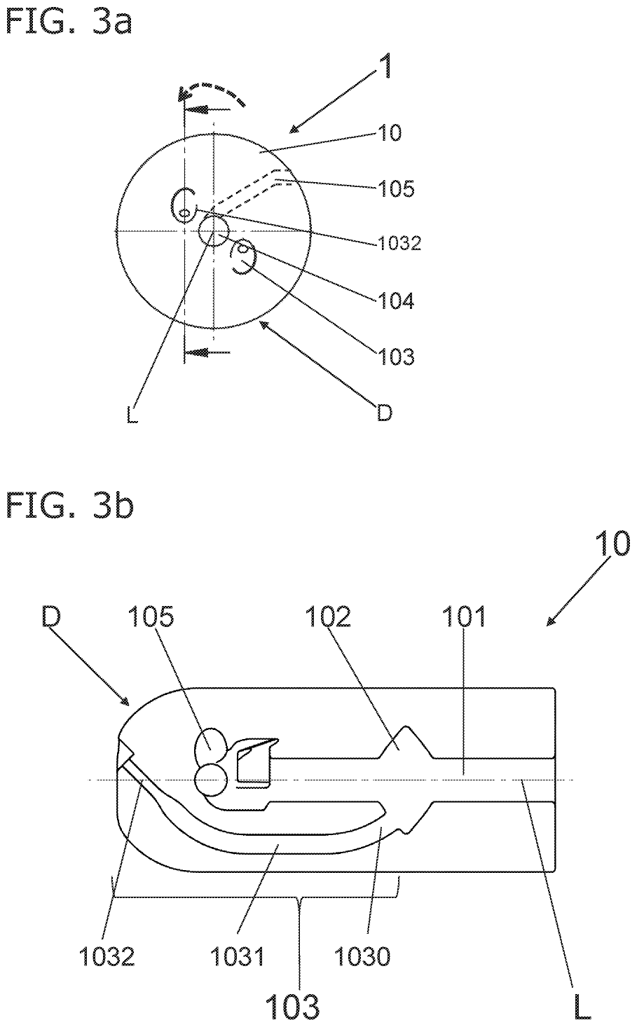

As is recognizable in the frontal view of the cross-jet cleaning nozzle 1 according to FIG. 3a, at least one front jet duct 104 can be arranged exiting centrally from the nozzle tip D. The front jet duct 104 has to be connected accordingly to the feed duct 101 in the interior of the rotor body 10. This also applies to at least one radial nozzle duct 105 indicated by dashed lines, which exits radially from the rotor body 10 slightly offset to the longitudinal axis L. If cleaning fluid exits from the front jet duct 104, a cleaning effect results in advance direction V, while liquid exiting through the at least one radial nozzle duct 105 results in the rotation of the rotor body 10. If one looks at the nozzle tip D from the side, the intersection of the fluid jets from the cross-jet nozzle ducts 103 is recognizable. In FIG. 3a, two cross jet nozzle ducts 103 are arranged offset to one another in the transverse direction. A cross jet nozzle outlet 1032 is recognizable at the end of the cross-jet nozzle ducts 103. An insert is also typically inserted here to enhance the nozzle effect.

The longitudinal section through the rotor body 10 according to FIG. 3b is shown in section along the section line marked with two arrows in FIG. 3a, wherein one of the two cross jet nozzle ducts 103 is shown in detail in the section. Adjacent to the left-out concentric feed duct 101, a branching duct 102 branches off and a part of the at least one radial nozzle duct 105 is shown. A part of a fastening means for fastening the stator body tip 205 (not shown) in the feed duct 101 is indicated.

The rotor body 10 is produced from metal by means of additive manufacturing methods or 3D printing. 3D printing methods are known in which metals or metal powders are applied layer by layer and bonded. Precise designs of above all the internal cross jet nozzle ducts 103 are thus possible, wherein the cross-jet nozzle ducts 103 do not have to be introduced later and additionally machined but are also left out layer by layer directly during the additive manufacturing. 3D printing is presently possible with high precision and corrosion-resistant cross jet cleaning nozzles 1 or associated rotor bodies 10 can be manufactured from metal. Technologies such as laser beam melting, electron beam melting, and laser sintering are used for the 3D printing of metals and metal alloys.

By way of additive manufacturing, a cross jet nozzle duct 103 having special shaping is possible, the course and diameter of which can vary arbitrarily. From the branching duct 102, which can also be omitted, the cross-jet nozzle duct 103 is left out here as a continuous opening, extending curved without edges, and comprising an inlet section 1030, a guide section 1031, and the cross-jet nozzle outlet 1032. The cross-jet nozzle duct 103 is curved toward the longitudinal axis L as a whole and forms an arc.

The entire cross jet nozzle duct 103 is manufactured seamlessly, without individually applied linear drilled holes. The individual sections each do not have a linear formation having stepped transitions or edges, as was known from the prior art. This curved edge-free shaping shown here is only possible by way of 3D printing. The entire cross jet nozzle duct 103 extends in a curve having continuously changing curvature and/or diameter, so that edges and stepped transitions are not formed between inlet section 1030, guide section 1031, and cross jet nozzle outlet 1032.

Inlet section 1030, guide section 1031, and cross jet nozzle outlet 1032 have different curvatures relative to the longitudinal axis L. The angle of the center of the cross-jet nozzle duct 103 relative to the longitudinal axis L extends without irregularities or jumps. In this case, the sections 1030, 1031, and 1032 preferably also have different diameters.

The entire cross jet nozzle duct 103 is formed by a continuous opening having inlet section 1030, the guide section 1031, and the cross-jet nozzle outlet 1032. Due to the absence of edges and corners, in operation, cleaning fluid is guided without obstructions in a curve up to the cross-jet nozzle outlet 1032 completely through the cross-jet nozzle duct 103, wherein the cleaning fluid only loses little energy due to lower friction.

The diameter of the cross-jet nozzle outlet 1032 is preferably smaller than the diameter of the guide section 1031 and/or the inlet section 1030.

Leaving out two continuous, arched, or curved cross jet nozzle ducts 103 formed without edges having the described sections is possible for the first time by means of 3D printing. Every cross-jet nozzle duct from the prior art was formed by multiple linearly drilled partial ducts, wherein edges and corners in the course of the cross-jet nozzle duct were the result.

The cross-jet cleaning nozzles introduced here are preferably fastened in practice on a lance of a lance device in order to apply cleaning fluid to them and use them for pipe cleaning. If multiple lances are each provided with a cross jet cleaning nozzle, multiple pipes or pipe bundles can be cleaned easily and automatically by guiding through the lances. In a further embodiment, the stator part 20 can be designed as part of the lance of the lance device.

### LIST OF REFERENCE SIGNS

1 cross jet cleaning nozzle
10 rotor body
101 feed duct
102 branching duct (in rotor body)
103 cross jet nozzle duct
   1030 inlet section
   1031 guide section
   1032 cross jet nozzle outlet (no inserts)
104 front jet duct/front jet nozzle (no inserts)
105 radial nozzle duct (facing radially away from the rotor body)
20 stator body
200 feed section
201 stator feed duct
202 recoil nozzle duct (inserts not shown)
203 rotor body mounting
204 central outlet
205 stator body tip
D nozzle tip
L longitudinal axis
V advance direction

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A rotor body of a cross jet cleaning nozzle, connectable to a stator including high-pressure line fitting, wherein a feed duct partially crosses the rotor body and from which at least one cross jet nozzle duct is left out in a manner extending branching off, wherein the cross jet nozzle duct includes an inlet section, a guide section, and a cross jet nozzle outlet, left out within the rotor body having various alignments relative to a longitudinal axis (L), so that a cleaning fluid can be transported from the feed duct up to a nozzle tip (D) and can be dispensed there from the cross jet nozzle outlet,
wherein:
the rotor body is completely produced from metal by means of additive manufacturing methods or 3D printing, wherein the cross-jet nozzle duct is left out during the additive manufacturing layer by layer as a continuous edge-free curved opening in the form of an arc curved in relation to the longitudinal axis (L).

2. The rotor body as claimed in claim 1, wherein the entire cross jet nozzle duct is manufactured seamlessly without individually applied linear drilled holes.

3. The rotor body as claimed in claim 1, wherein in operation cleaning fluid can be dispensed without obstructions completely through the cross-jet nozzle duct in a curve up to the cross-jet nozzle outlet from the nozzle tip (D).

4. The rotor body as claimed in claim 1, wherein the inlet section, the guide section, and the cross-jet nozzle outlet of the cross-jet nozzle duct respectively have curvatures in relation to the longitudinal axis (L) different from one another and/or different diameters.

5. The rotor body as claimed in claim 1, wherein the diameter of the cross-jet nozzle outlet is smaller than the diameter of the guide section and/or the diameter of the inlet section.

6. The rotor body as claimed in claim 1, wherein at least one radial nozzle duct is left out in the rotor body, branching off from the feed duct and at least approximately facing radially away from the rotor body.

7. The rotor body as claimed in claim 1, wherein at least one front jet duct is left out in the rotor body, exiting from the nozzle tip (D), and branching off from the feed duct.

8. A production method for manufacturing a rotor body of a cross jet cleaning nozzle as claimed in claim 1, wherein the rotor body is completely produced from metal by means of additive manufacturing methods or 3D printing and the cross jet nozzle duct is left out during the additive manufacturing layer by layer as a continuous edge-free curved opening in the form of an arc curved in relation to the longitudinal axis (L).

9. A lance of a lance device for cleaning pipe bundles, wherein at least one cross jet cleaning nozzle having a rotor body as claimed in claim 1 is arranged and usable.
